(19) United States
(12) Patent Application Publication
(10) Pub. No.: US 2002/0170980 A1
(43) Pub. Date: Nov. 21, 2002

(54) Spray fire hose

(76) Inventor: Walter Lee Brim, Titusville, FL (US)

Correspondence Address: Walter L. Brim, 1500 Putter Ct., Titusville, FL, 32780, US

(21) Appl. No.: 10/144,135

(22) Filed: May 11, 2002

Related U.S. Application Data
(60) Provisional application No. 60/290,616, filed on May 14, 2001.

(51) Int. Cl. A62C 31/22

(52) U.S. Cl. 239/276

(57) ABSTRACT

The Spray Fire Hose is design for fire trucks, pumps and, can be fabricated for domestic use. The Spray Fire Hose is formed with connecting horizontal hoses and several vertical hoses with spray nozzles attached at the top. The nozzles will be able to be change by screwing it on and off the vertical hose, different types of nozzles can be used. The vertical sprayers and the horizontal hoses are screwed into inverted “T” like cylinders. The water will come out of the nozzles and cover the near ground area. The Spray Fire Hose can be stored in the back of a fire truck. When approaching the area where the fire is located, put the hose on the ground and go forward. Examine the distance on how far you should be away from the fire, when setting up the hose. When putting down the hose, attach it to the fire truck or a pump then stabilize the hose with the stakes. Now turn on the water and the water will saturate the area, which aid in preventing the fire from spreading.

### BACKGROUND OF THE INVENTION

Field of the Invention

The present invention relates to a fire hose for fire trucks, and pumps. More particularly, the present invention pertains to a new and improved fire hose. The regular conventional fire hose can only spray one area at a time. The spray fire hose provide the firemen another way to prevent the spreading of fires. The Spray Fire Hose can saturate more than one area at a time. The Spray Fire hose is equip with vertical hoses with spray nozzles, erected on connecting horizontal hoses. The hose is kept in place with stakes. The hose can be has long as needed. The hose can be extended by screwing the hoses into inverted “T” like cylinders. There are only horizontal hoses offered in the industries now.

As such, it may be appreciated that there continues to be a need for a new and improved fire hose as set forth by the instant invention which addresses both the problems of ease to use as well as effectiveness in construction and in this respect, the present invention substantially fulfills this need.

### BRIEF DESCRIPTION OF THE DRAWINGS

This application is based on the provisional file on May 14, 2001, JC971 U.S. PTO 60/290,616.

For a more complete appreciation of the Spray Fire Hose, examine the attendant advantages thereof which will become better understood by reference to the following detailed description when considered in connection with the accompany drawings where in:

FIG. 1 Shows the nozzle detached from the vertical hose.

FIG. 2 Shows the face of the nozzle and the top side view of the vertical hose.

FIG. 3 Shows the stake that support the hose.

FIG. 4 Shows the inverted “T” like cylinder with the vertical hose and the connecting side hoses, being supported by the stake.

FIG. 5 Shows the top view of the supporting stake.

FIG. 6 Shows the bottom view of the supporting stake.

FIG. 7 Shows the side view of the supporting stake.

FIG. 8 Shows the front view of the supporting stake.

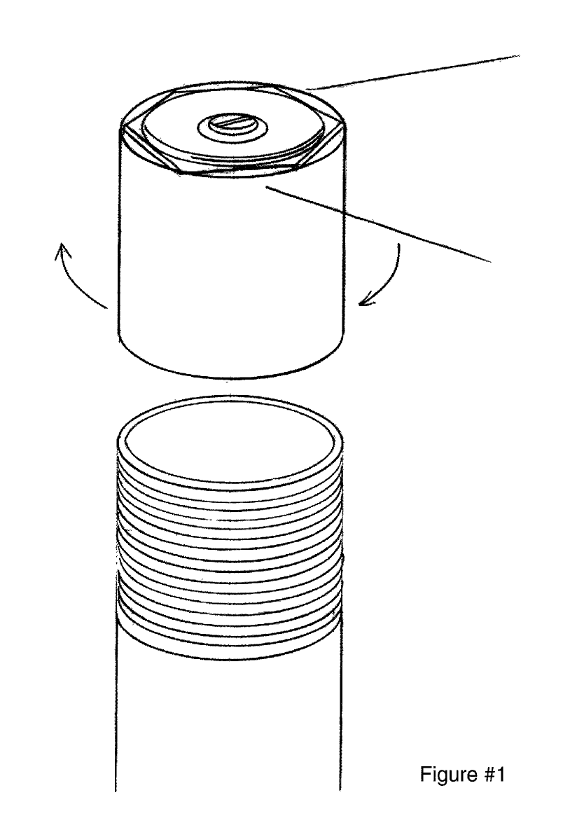

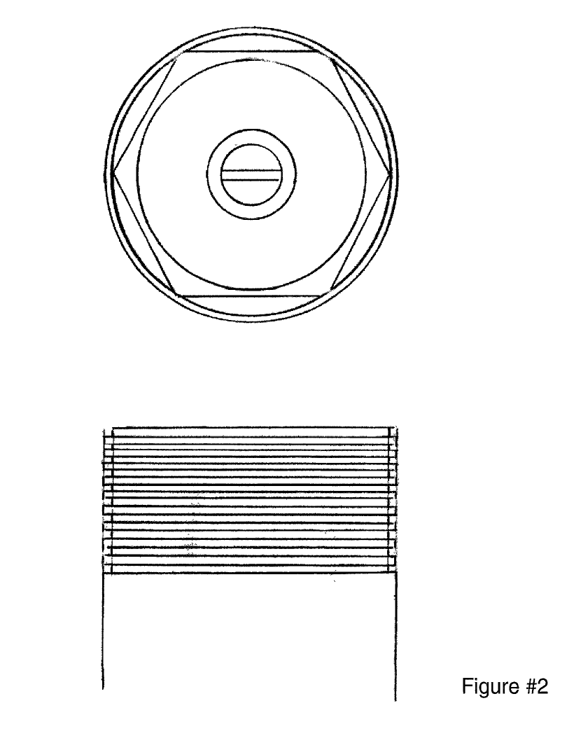

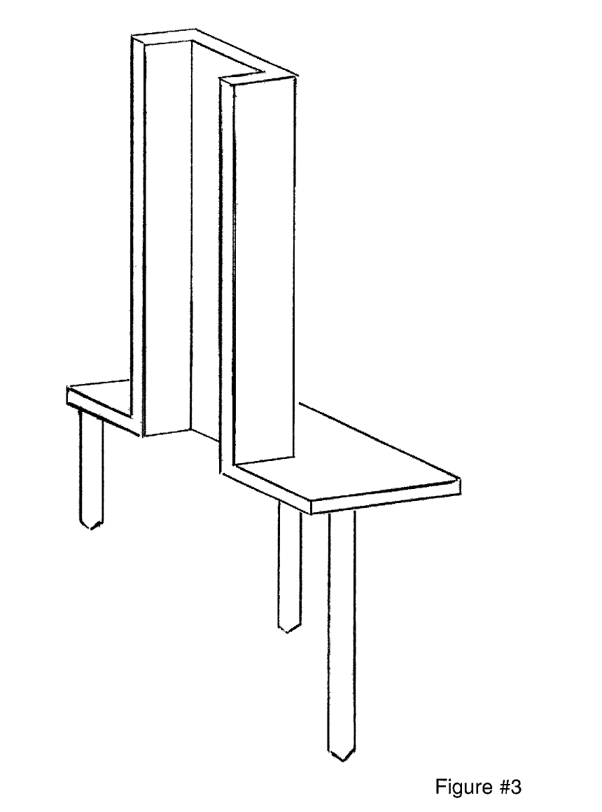

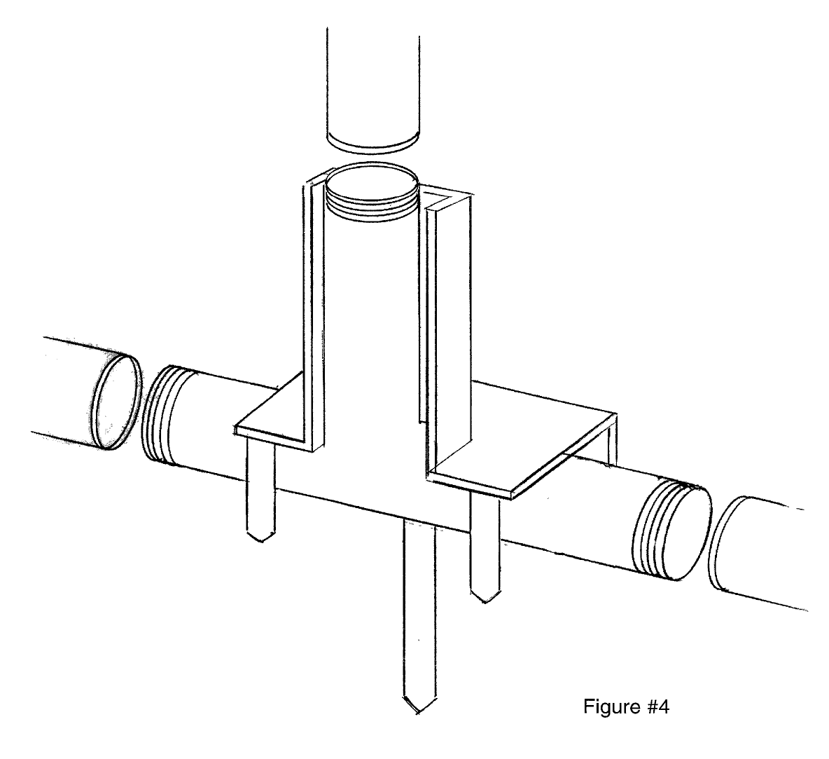

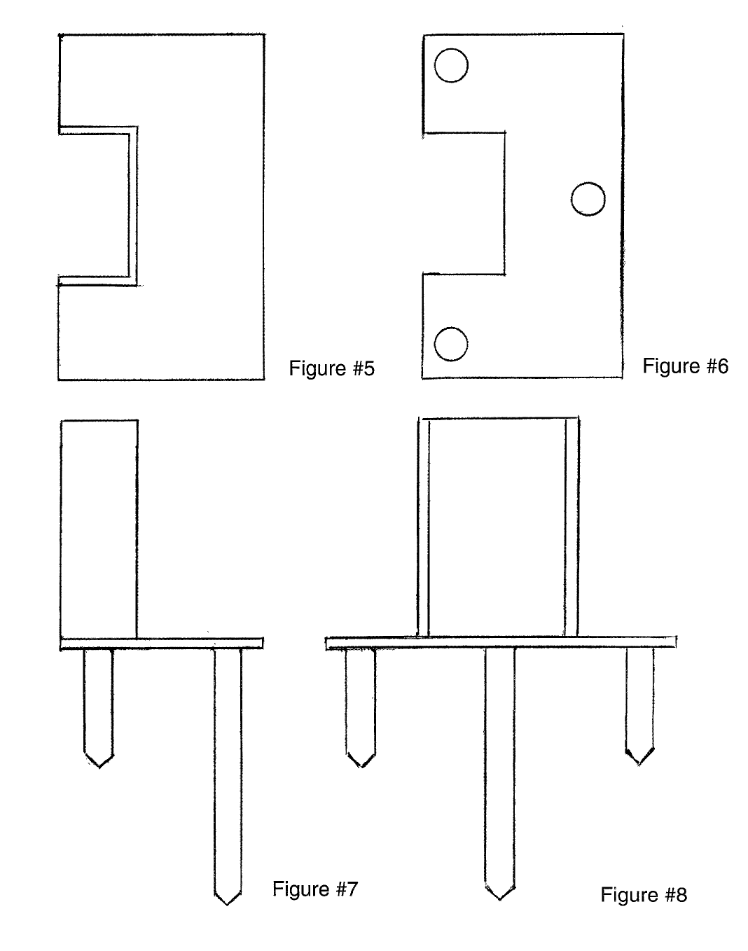

### SUMMARY

It is therefore an object of the present invention is to provide help in preventing the spreading of fire.

One object of the present invention is to provide a new and improved fire hose. This fire hose is design to help prevent the spreading of fire.

Another object of the present invention is to save time by saturating more ground with water or foam, than the conventional hose.

There is still another object of the present invention, it can also be fabricated for domestic use. This invention can be used to help save a house from fire. It also can be used as a portable sprinkler system.

These valuable objects and advantages of the present invention is form with connecting horizontal hoses and several vertical hoses with spray nozzles attached at the top. The nozzles will be able to be change by screwing it on and off the vertical hose, different types of nozzles can be used. The hoses are connected together by inverted “T” like cylinders.

The new invention has stakes to keep it in place when in uses.

It should further be recognized that the present invention provides great advantages for both industrial and domestic use.

The spray fire hose, is created as follows:

1. The vertical hoses are perpendicular to the horizontal hoses, which are all held together by inverted “T” like cylinders. The vertical hoses has spray nozzles at the top. The hose can be extended by connecting the hoses to more inverted “T” like cylinders.

2. The stakes support the hose and the sprayers.
